(19) United States
(12) Patent Application Publication
(10) Pub. No.: US 2011/0233222 A1
(43) Pub. Date: Sep. 29, 2011

(54) VEHICLE FRAME WITH ACCESSORY HOLDER

(75) Inventor: Aaron M. Bethlenfalvy, Southbury, CT (US)

(73) Assignee: Pacific Cycle, LLC, Madison, WI (US)

(21) Appl. No.: 12/730,712

(22) Filed: Mar. 24, 2010

(51) Int. Cl. B65D 25/00; B62K 3/02

(52) U.S. Cl. 220/737; 280/281.1

(57) ABSTRACT

A vehicle frame has an accessory holder. The vehicle frame includes a seat support member, a head frame member for supporting vehicle handlebars, and a top frame member extending between the seat support member and the head frame member. The top frame member is shaped to accommodate an accessory holder, and an accessory holder is disposed at least partially within the top frame member. The accessory holder may be integrally formed with the frame or fastened into the vehicle frame.

### BACKGROUND OF THE INVENTION

The present invention relates generally to vehicle frames. Specifically, the present invention relates to a vehicle frame, such as a bicycle or motorcycle frame, with an integrally formed accessory holder.

Accessory holders on vehicles like bicycles and motorcycles are well known in the art. Most accessory holders are designed to mount to standard vehicle frames or handlebars. For example, bottle holders are common add-on accessories for bicycles. U.S. Pat. No. 4,630,239 to Tackles et al. shows a cage-style bottle holder for use on a bicycle. The cage-style holder disclosed by Tackles et al. is typical of cage-style bottle holders, which are generally attached to the down tube on a bicycle frame. This location is generally out of the rider's way, but it is not easily accessible. The rider must reach underneath the vehicle frame's top frame member to access the bottle, and often pull and push at awkward angles to release and re-insert the bottle into the holder. There are many variations in the shape, structure and method of attachment used for cage-style bottle holders, all of which are separate devices to be added on to a standard bicycle frame.

Other types of accessory holders are also available, including those that generally mount to the handlebars of a bicycle, motorcycle or other vehicle. U.S. Pat. No. 6,357,708 to Carson shows one style of handlebar-mounted accessory holder. As with the accessory holders described above, there are many different shapes, structures and attachment mechanisms in use with prior art handlebar-mounted accessory holders. When mounted on the handlebars, the accessory holders may interfere with the rider's use of the handlebars for steering and may cause weight imbalances that make riding more difficult.

Still other designs may be mounted to a bicycle's top tube or seat support tube. While there are a multitude of different accessory holder designs available for use on bicycles, motorcycles and other like vehicles, most are not optimally designed for use by the rider. Because placement of accessory holders is not contemplated in standard vehicle frame designs, the add-on accessory holders available in the prior art are often in awkward locations that are not easily accessible or that interfere with other features of the vehicle or the rider.

Accordingly, a need exists for an accessory holder that is integrally designed with the vehicle frame. This invention relates to improvements to the devices described above, and to solutions to some of the problems raised or not solved thereby.

### SUMMARY OF THE INVENTION

The present invention provides a vehicle frame for a vehicle including a seat and a set of handlebars. One embodiment of the vehicle frame includes a seat support member, a head frame member for supporting the vehicle handlebars, and a top frame member extending between the seat support member and the head frame member. The top frame member is shaped to accommodate an accessory holder, and an accessory holder is disposed at least partially within the top frame member. The accessory holder may be integrally formed with the frame or fastened into the vehicle frame. One embodiment of the accessory holder includes a body and a receptacle, where the body includes a lower portion extending below the top frame member.

The present invention also contemplates a bicycle frame including a seat support member, a head frame member, a first top frame member extending between the head frame member and the seat support member, and a second top frame member extending between the head frame member and the seat support member. The first top frame member and the second top frame member are shaped to accommodate an accessory holder therebetween. In one embodiment, the first and second top frame members are formed from tubing material. In another embodiment, the first and second top frame members are bent outwardly away from one another to accommodate the accessory holder.

Because the vehicle frame is shaped to accommodate the accessory holder, many problems associated with the prior art are significantly improved or eliminated. For example, the accessory is accessible from above the top frame member, eliminating the awkward reach required when using accessory holders mounted to the down frame member or seat support member. The present invention also makes an effective use of space, keeping a majority of the receptacle space below the top frame member and out of the rider's way.

### BRIEF DESCRIPTION OF THE DRAWINGS

FIG. 1 is a perspective view of one embodiment of a vehicle frame of the present invention, showing the frame supporting a front fork, seat post and handlebar mount for the vehicle;

FIG. 2 is a top view of the vehicle frame of FIG. 1;

FIG. 3 is a side view of the vehicle frame of FIG. 1;

FIG. 4 is an enlarged, perspective view of FIG. 1, illustrating one embodiment of the accessory holder of the present invention;

FIG. 5 is a side view of the accessory holder of FIG. 4;

FIG. 6 is a top view of the accessory holder of FIG. 4;

FIG. 7 is a perspective view of another embodiment of the accessory holder of the present invention, showing the accessory door open;

FIG. 8 is a perspective view of the accessory holder of FIG. 7, showing the accessory door closed; and

FIG. 9 is a top view of the accessory holder of FIG. 8.

### DETAILED DESCRIPTION OF THE PREFERRED EMBODIMENTS

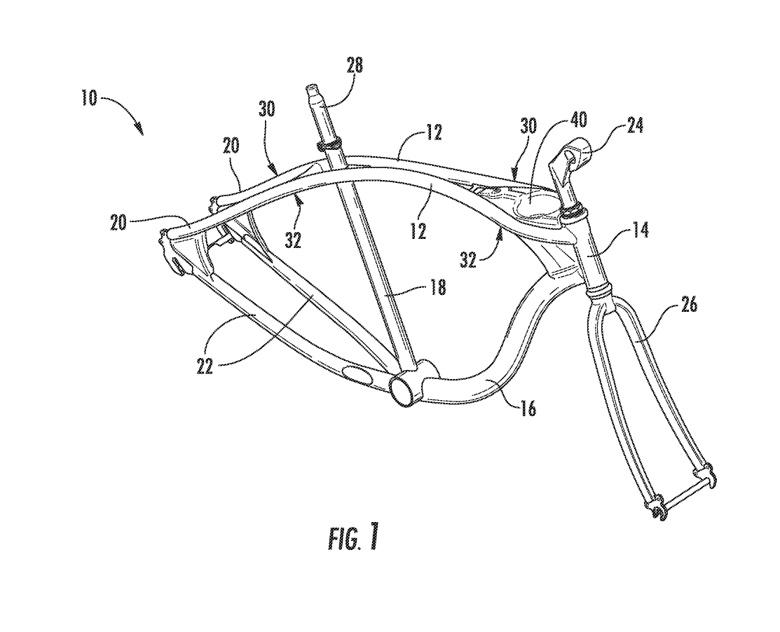

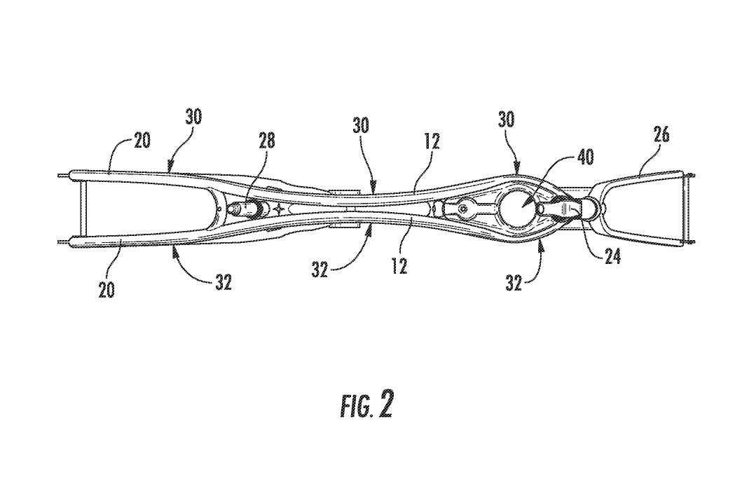

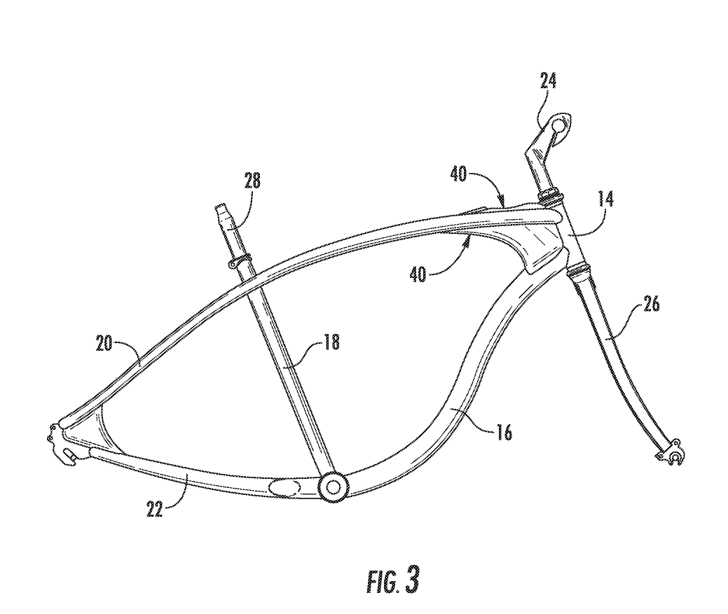

Referring now to the drawings, FIGS. 1-3 show one embodiment of a vehicle frame with an accessory holder according to the present invention, wherein the vehicle frame is a bicycle frame. A typical bicycle frame includes a series of frame members, often referred to as tubes because they are generally manufactured using tubing material. FIGS. 1-3 show a bicycle frame 10 including top frame members 12, a head frame member 14, a down frame member 16, a seat support member 18, seat stay members 20 and chain stay members 22. The head frame member 14 supports the handlebar mount 24 and front fork 26, the seat support member 18 supports the seat post 28 and seat (not shown).

The top frame member 12 and seat stay member 20 shown in the figures are comprised of two continuous tubes 30, 32 that extend from the head frame member 14 to the seat support member 18 and down to the hub of the rear wheel (not shown). Other embodiments where the top frame member and seat stay member are separate elements joined at the seat support member are also possible for use with the present invention.

The top frame member 12 is shaped to accommodate an accessory holder 40 therebetween. In the embodiment shown, tubes 30, 32 are bent outwardly to accommodate the accessory holder 40. However, top frame member 12 could be a single tube or other frame element that widens to accommodate or integrally form the accessory holder 40.

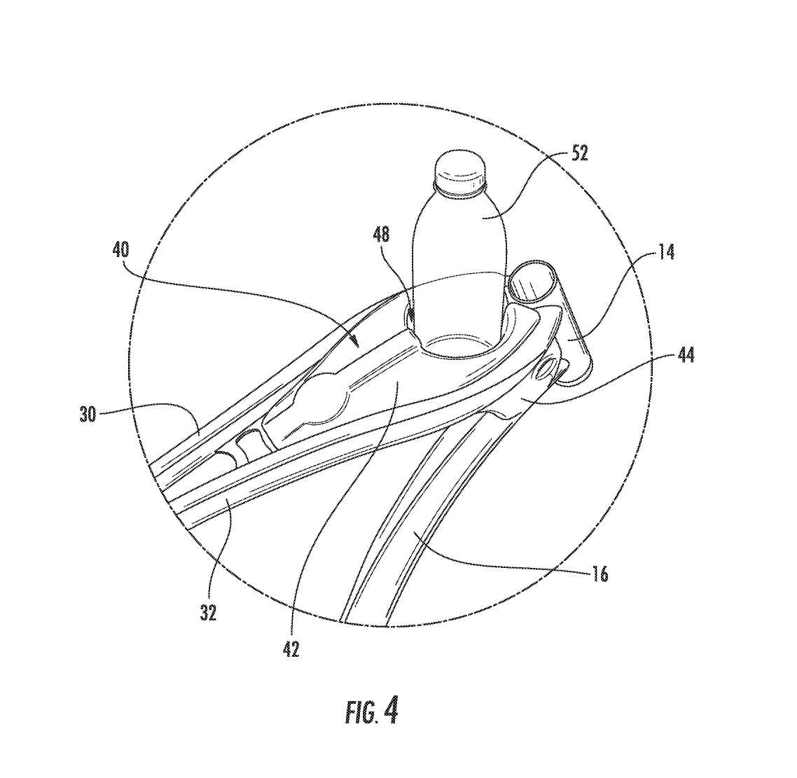

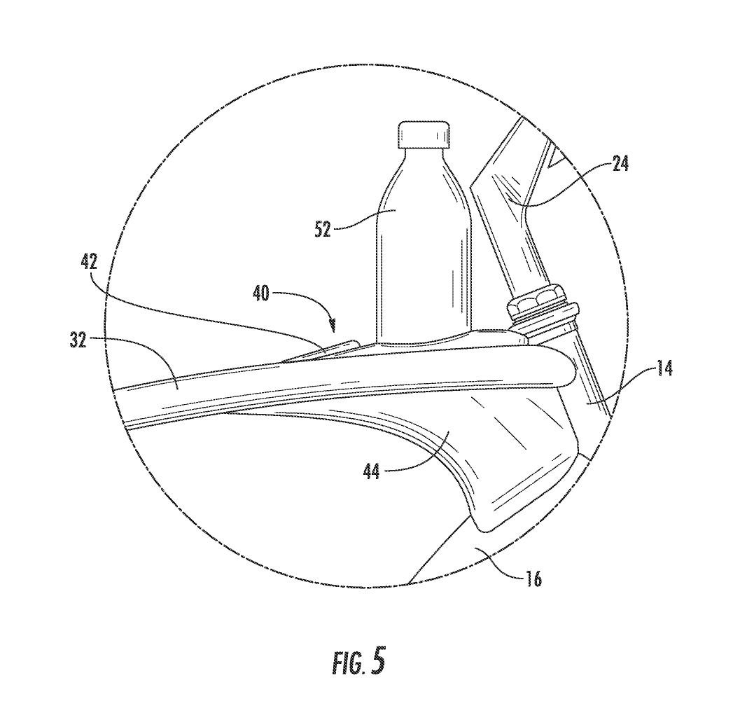

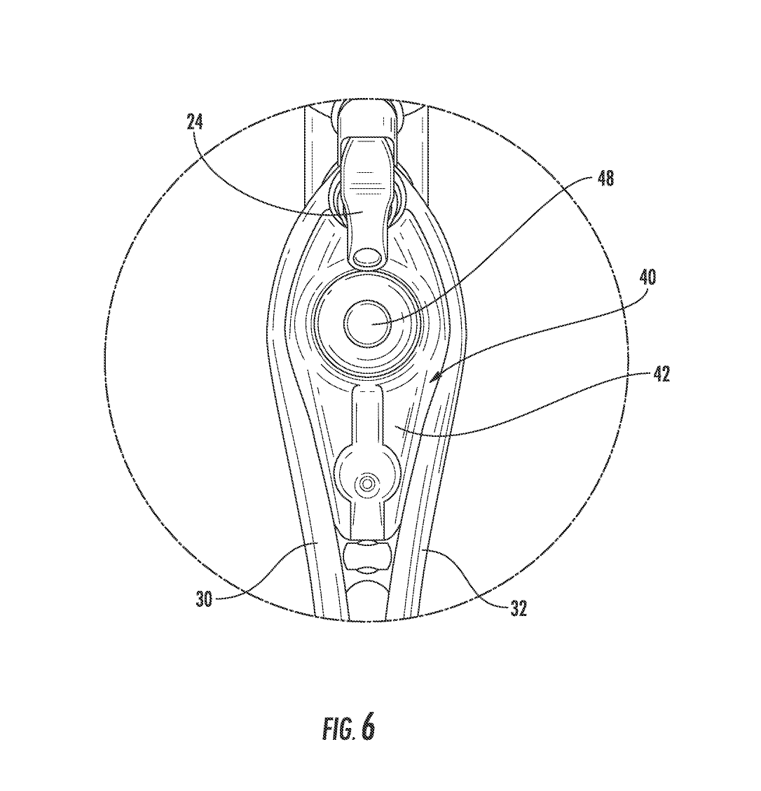

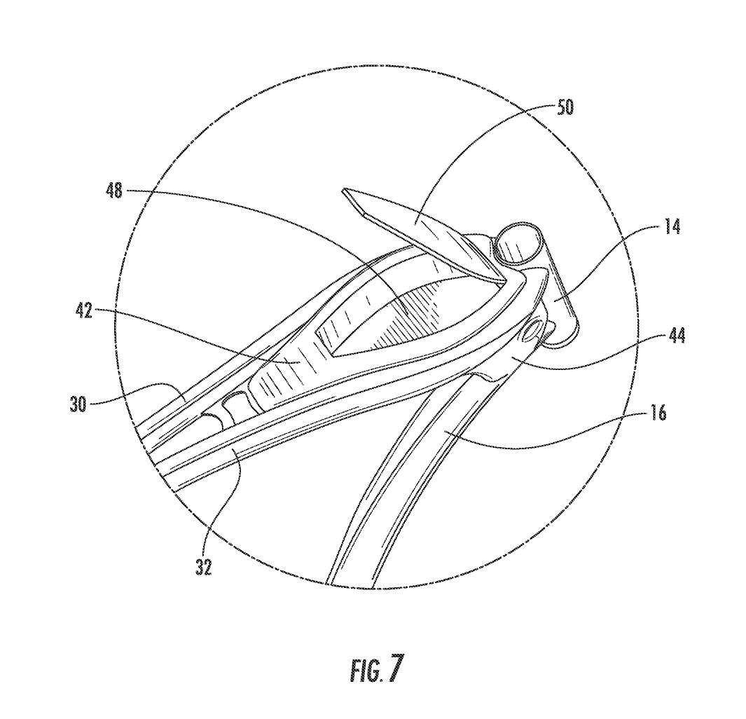

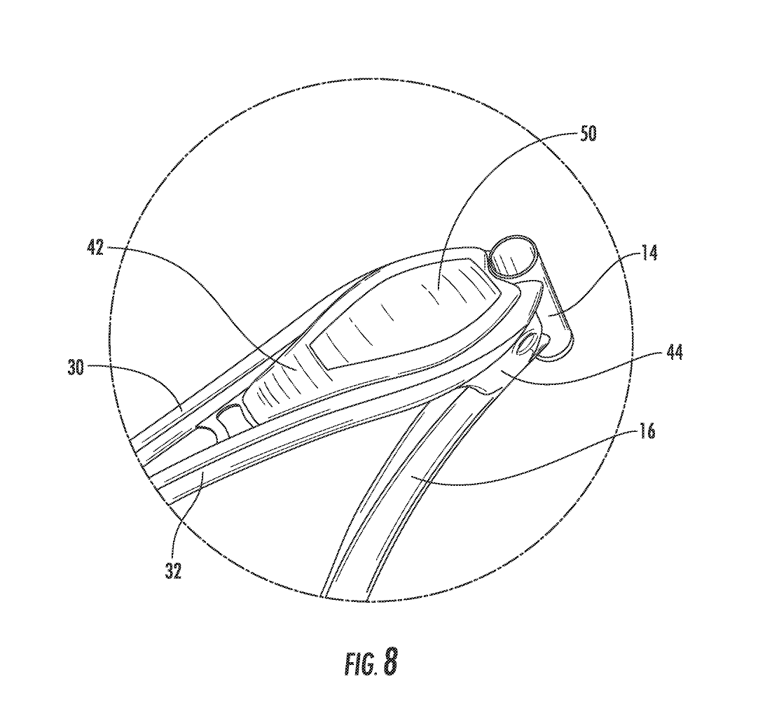

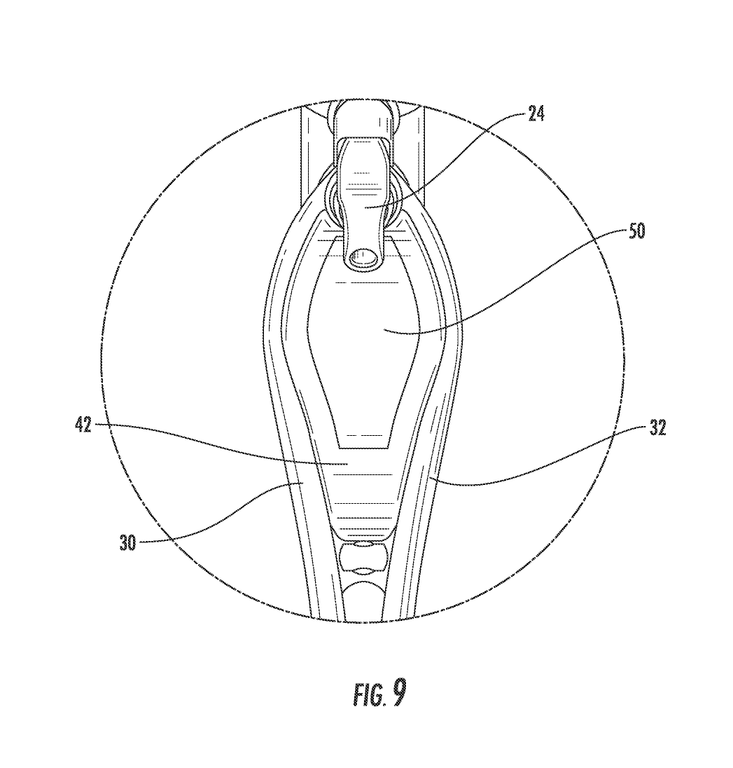

Two embodiments of an accessory holder 40 are shown in the figures. Each embodiment includes a body 42 and a receptacle 48. The body 42 shown includes a lower portion 44 that extends below the top frame member 12 to the down frame member 16 and back to the head frame member 14. In FIGS. 1-6, the accessory holder 40 is a bottle holder with a substantially cylindrical receptacle 48 to hold bottles 52. In FIGS. 7-9, the accessory holder 40 includes a receptacle cover 50 and can be used to hold a variety of accessories, including but not limited to keys, wallets, and the like.

The accessory holder 40 could be integrally formed with the vehicle frame 10, or could be a separately manufactured piece or pieces that are fastened into the frame by any number of means well known in the art such as welding, screwing, gluing, snap-fitting, etc. The accessory holder 40 could be of a number of shapes and sizes, and used for a number of accessories or purposes. The present invention could also be used in connection with other vehicles, such as motorcycles, riding lawn mowers, and all-terrain vehicles.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

I claim:

1. A vehicle frame for a vehicle including a seat and a set of handlebars, the vehicle frame comprising:
a seat support member;
a head frame member for supporting the vehicle handlebars;
a top frame member extending between the seat support member and the head frame member, the top frame member shaped to accommodate an accessory holder; and
an accessory holder disposed at least partially within the top frame member.

2. The vehicle frame of claim 1, wherein the accessory holder is a bottle holder.

3. The vehicle frame of claim 1, wherein the accessory holder includes a body and a receptacle.

4. The vehicle frame of claim 1, wherein the top frame member includes at least two tubular frame elements.

5. The vehicle frame of claim 4, wherein the at least two tubular frame elements are bent outwardly to accommodate the accessory holder.

6. The vehicle frame of claim 1, wherein the accessory holder is integrally formed with the frame.

7. The vehicle frame of claim 1, wherein the accessory holder fastens into the vehicle frame.

8. The vehicle frame of claim 1, wherein the accessory holder includes a body and a receptacle, the body including a lower portion extending below the top frame member.

9. The vehicle frame of claim 1, wherein the accessory holder includes a receptacle accessible from above the top frame member.

10. A bicycle frame comprising:
a seat support member;
a head frame member;
a first top frame member extending between the head frame member and the seat support member;
a second top frame member extending between the head frame member and the seat support member, wherein the first top frame member and the second top frame member are shaped to accommodate an accessory holder therebetween.

11. The vehicle frame of claim 1, wherein the first and second top frame members are formed from tubing material.

12. The vehicle frame of claim 1, wherein the first and second top frame members extend beyond the seat support member.

13. The vehicle frame of claim 1, wherein the first and second top frame members are bent outwardly away from one another to accommodate the accessory holder.

14. The vehicle frame of claim 1, wherein the accessory holder includes a receptacle accessible from above the top frame members.

15. An accessory holder for a vehicle, the accessory holder comprising:
a body shaped to fit at least partially within a top frame member of a vehicle; and
a receptacle accessible from above the top frame member of the vehicle and extending below the top frame member of the vehicle

16. The accessory holder of claim 15, wherein the accessory holder is integrally formed with the vehicle frame.

17. The accessory holder of claim 15, wherein the receptacle is a cylindrical shape.

18. The accessory holder of claim 15, wherein the accessory holder is a bottle holder.

19. The accessory holder of claim 15, further comprising a cover for the receptacle.

20. The accessory holder of claim 15, wherein the accessory holder is fastened into the vehicle frame.
